(19) United States
(12) Patent Application Publication
(10) Pub. No.: US 2016/0198641 A1
(43) Pub. Date: Jul. 14, 2016

(54) POT WITH INTERCHANGEABLE SAUCER AND PEDESTAL

(71) Applicant: Lee's Pottery Inc., San Bernardino, CA (US)

(72) Inventor: David Lee, San Bernardino, CA (US)

(21) Appl. No.: 14/596,216

(22) Filed: Jan. 14, 2015

(51) Int. Cl. A01G 9/02

(52) U.S. Cl. CPC A01G 9/02; A01G 9/021

(57) ABSTRACT

A pottery ware includes a pot that interchangeably mates with universal saucers and pedestals. A base connection aperture joins with a saucer protrusion to mate the pot with the saucer. The pot has an etched portion with uneven surface on its outer surface for forming a frictional grip. The etched portion provides sufficient grip to create a stable stacked configuration. The pot is defined by a base having at least one base drainage aperture and at least one ridge that enables controllable passage of excess water into a concentric, detachable saucer. A saucer base has a saucer drainage aperture that rotates relative to the base drainage aperture to selectively control the flow of water from the pot.

### FIELD OF THE INVENTION

The present invention relates generally to a pot with interchangeable saucer and pedestal. More so, a pottery ware provides a pot that has threaded members for enabling rotatable interchangeability with a universal saucer and a universal pedestal.

### BACKGROUND OF THE INVENTION

Typically, pottery is the ceramic act of making pottery for plants. Pottery is made of plastic and very popular now, of which major types include earthenware, stoneware, and porcelain, composite plastic made mostly of stone powder and polypropylene while the thin resin plastic is made of either polyethylene or polypropylene. The pottery is used to contain, liquids, plants, and any number of objects. Various forms of plant pots are known for growing plants. Typical plant pots are either, of generally cylindrical, frustoconical or rectangular prism form. Frustoconical type plant pots, or other plant pots which are tapered so that the bottom of each pot is narrower than the top, are advantageous over cylindrical or rectangular prism type pots in that they are often able to be located at least partially within each other and thereby able to be stacked for transport, storage and display, thereby realizing considerable space savings.

Generally, however, such plant pots cannot be stacked-one on top of another-in any suitable manner for use. Many pot plant enthusiasts like to arrange several pots in a generally vertical relationship for particular aesthetic appeal and saving of space. Such an arrangement currently typically depends on use of a separate stand to mount the pots or the hanging of one pot from another with chains or the like.

It is known that pottery and similar containers can be shaped by a range of methods that include hand shaping, potter's wheel, granulate pressing, injection molding, to molding and blow molding. Various decorative methods can be applied to the finished pottery to enhance the decorative aspects. These include, carving, brandishing, painting, and carving.

It is recognized that, although plant pots come in a variety of different sizes and shapes, the vast majority of plant pots are configured in virtually the same way, that being a container having a hole or holes in or near the bottom of the pot as a drainage portal for the gravitational drainage of water from the plant. The drainage portals allow excess water, fertilizers, chemicals, and other liquids poured into the plant soil to advantageously drain out of the pot instead of building up in the pot and harming the plant. However, the drainage is not easily to control. Often lesser draining may be needed, such as when leaving the plant unattended for numerous days. Most composite resin plastic today don't even have holes in the bottom of the pots. Customers would need to drill the holes for drainage.

Typically, composite resin planters constructed of a mixture of stone powder and PU plastic have the benefit of allowing greater wall thickness which provides improved insulation, stability due to increased weight and a higher perceived look and feel, due to a visual appearance much closer to true ceramic pottery. It is known in the art that there are injection molded plastic that has attached saucers. However, these are often not screwed on, they are attached with plugs. Injection molded plastic is generally thinner and lighter than composite resin plastic.

Other proposals have involved for stackable pottery ware that drain water and nutrients from their base. The problem with these devices is that they do not provide detachable saucers, a stable stacking configuration, and selectively controlled apertures for drainage of water.

Thus, an unaddressed need exists in the industry to address the aforementioned deficiencies and inadequacies. Even though the above cited methods for pottery ware meets some of the needs of the market, pottery ware that is adapted to stack one or more similar pottery ware, and interchange various types of saucers and pedestals is still desired.

### SUMMARY OF THE INVENTION

The present invention is directed to a pottery ware that provides a pot that has threaded members for enabling rotatable interchangeability with a universal saucer and a universal pedestal. In some embodiments, the pottery ware may include a pot, a detachable saucer, and a detachable pedestal. The pot may be configured to have an etched portion on an external surface for forming a frictional grip to stack one or more similar pots. The pot may also be defined by a base having at least one base drainage aperture and at least one ridge that enables controllable passage of excess water into a concentric, detachable saucer. The saucer may have at least one saucer drainage aperture that rotates relative to the at least one base drainage aperture to selectively control the flow of water from the pot. The etching on the pot is not for frictional grip, only for decoration. However, in some embodiments, no etching may be used.

Additionally, the pottery ware is designed so that multiple styles of saucers and pedestals can be used interchangeably with multiple styles of planter bodies. The benefit of these universal saucers and pedestals to both the manufacturer, retailer and end use customer are as follows: 1) Cost savings by allowing the same steel mold to be shared between multiple styles of planters 2) Customizable styles—The interchangeable saucers, pedestals and planter bodies allows the manufacturer, the retailer and/or the end-use customer to create multiple configurations of planters and urns, while only having to manufacture, stock and purchase a minimal number of interchangeable elements (planter bodies, Universal saucers, Universal Pedestals).

Typically the high cost of manufacturing steel molds limits the number of different style options that a manufacturer can reasonably offer to retailer. Likewise, the limited amount of shelf space available, per retail store, limits the number of style options the retailer can offer to the end use customer. By providing the pottery ware composed of a small number of interchangeable pieces that can be assembled into many different style configurations, the effective number of style options offered to the end use customer can be increased, without added cost to the manufacturer or added shelf space to the retailer.

The pot may be shaped and dimensioned into various forms, including, without limitation, cylindrical, bell-shaped, frustoconical, or rectangular prism forms. The pot may be used for various purposes, including, without limitation, growing plants, displaying flowers, cooking, and general ornamental affects. The pottery ware is especially effective for secure stacking of one or more pots, and controlled release of excess water into a detachably joined saucer. It is significant to note that the pottery ware is not suitable for cooking.

It is one goal of the present pottery ware is to cover all items in this product line, encompassing a wide range of styles and shapes of pottery ware. The etched stripe has been provided as just one example. The commonality among all the pottery ware in the product line is the attachable/detachable/interchangeable saucers and pedestals, including the universal saucer, in-line saucer, and universal pedestal. The means by which these saucers and pedestals attach and the interchangeable, i.e., universal functionality are the primary focus for the patent. 2) Most but not all of the pottery ware shapes in the product line is stackable. 3) Not all the styles include etching. 4) The controllable drainage feature may or may not be incorporated at this time.

In some embodiments, the pot may be defined by an outer surface and an inner surface that forms a cavity. The pot may also be defined by a base, a central region, and an opening in communication with the cavity. The pot is adapted to be stacked with one or more similar pots. This stacked configuration may include a generally vertical relationship for particular aesthetic appeal and saving of space. The outer surface comprises an etched portion that has an uneven surface and slightly protrudes from the outer surface of the pot. The etched portion may be positioned anywhere along the length of the pot, from the base to the opening.

In one embodiment, the etched portion forms a series of bands proximal to the opening, near an upper end of the pot. The etched portion frictionally engages the inner surface of an outer pot in the stacked configuration. The etched portion may have small ridges that form an uneven outer surface, which is in contrast to the relatively smooth, non-etched surface of the pot. However, the etching is not important for stacking purposes.

The base further includes a generally concentric base connection aperture arranged adjacent to a base drain aperture. The saucer is defined by a saucer base having a saucer protrusion. The base connection aperture engages the saucer at the generally concentric saucer protrusion to form a detachable connection. The connection between the base connection aperture and the saucer protrusion may use various mating mechanisms, including, without limitation, a threaded surface, friction, a magnets, and adhesives. The base may also include at least one base ridge that slightly protrudes from the surface of the base. The at least one base ridge creates additional space between the base and the saucer to enable more water to accumulate in the saucer.

It is a key innovative feature of the present invention that the saucer and a plurality of pedestals are interchangeable on the pot. Any combination of saucers and pedestals can be attached, detached, and operational with the pot. For example, a universal saucer joins with the pot. The universal saucer has a high upper flange and provides a perimeter space for collecting falling leaves from the plant, excess water, and the like. In another example of interchangeability, an inline saucer can be attached to the pot. The inline saucer forms a substantially seamless appearance with the pot. Additionally, a plurality of pedestals may be used.

The pedestals can be short, tall, wide, decorative, and have myriad other physical attributes. This interchangeable feature allows one body to be configured into multiple types of different pots and urns by means of interchangeable universal saucers and universal pedestals. Yet another key feature in the pottery ware includes a hole in the screw, which can be used for fastening purposes. The benefit of the attachable saucer to the end user is the functionality of the saucer to improve plant health by increasing availability of water to plant roots. The attachable saucer also protects floor surfaces from water damage, by capturing excess water that drains from the planter.

In some embodiments, the pot may be used to retain a plant for growth, watering, and display. Following watering, the base of the pot is adapted to purposely direct the flow of the water through at least one base drainage aperture, and retain a desired amount of the water within a saucer for a controlled period of time. The saucer may also enable passage of water that accumulates in the saucer base through at least one saucer drainage aperture. The base drainage aperture may be in communication with the saucer drainage aperture. The saucer may be rotated relative to the base to selectively increase or decrease the flow rate of the water through the respective drainage apertures. In this manner, the flow of water can be inhibited sufficiently to timely allow a plant to receive a sufficient amount of moisture. Furthermore, the saucer is defined by a radial upper flange. The upper flange helps retain the water on the saucer base to prevent overflow and spillage.

One objective of the present invention is to provide aesthetic, functional pottery ware for growing plants, displaying flowers, cooking, and general ornamental affects.

Another objective is to create interchangeable saucers and pedestals for the pot. So as to enable the pottery ware to function with a variety of universal saucers and universal pedestals.

Another objective is to form a decorative etch around the pot that creates frictional grip between an outer surface and an inner surface of two stacked pots.

Yet another objective is to enable controllable release of water from the cavity of the pot through a base drainage aperture and/or a saucer drainage aperture.

Yet another objective is to selectively rotate the saucer to control the rate of water flow through the base and the saucer.

Yet another objective is to threadably mate the base connection aperture to the saucer protrusion.

Yet another objective is to provide cost effective pottery ware that is both decorative and functional.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary pot having an exemplary etched portion on an outer surface that is joined with an exemplary saucer, in accordance with an embodiment of the present invention;

FIGS. 2A, 2B, and 2C illustrate perspective views of the pot joined with the saucer, where FIG. 2A is the pot without the saucer, FIG. 2B is the pot with an exemplary universal saucer, and FIG. 2C is the pot with an exemplary inline saucer, in accordance with an embodiment of the present invention;

FIGS. 3A, 3B, and 3C illustrate perspective views of the pot in a stacked configuration with at least one other pot, where FIG. 3A is the pot without the saucer and in the stacked configuration, FIG. 3B is the pot with an exemplary universal saucer and in the stacked configuration, and FIG. 3C is the pot with an exemplary inline saucer and in the stacked configuration, in accordance with an embodiment of the present invention;

FIGS. 4A and 4B illustrates perspective views of the pot joining the saucer, where FIG. 4A illustrates the base of the pot joining an inline saucer, and FIG. 4B illustrates the base of the pot joining a universal saucer, in accordance with an embodiment of the present invention;

FIG. 5 illustrates a close-up view of an exemplary base connection aperture mating with an exemplary saucer protrusion, in accordance with an embodiment of the present invention; and

FIGS. 6A and 6B illustrate a perspective view of an exemplary pedestal with a pedestal housing and with pedestal fasteners, in accordance with an embodiment of the present invention.

Like reference numerals refer to like parts throughout the various views of the drawings.

### DETAILED DESCRIPTION OF THE INVENTION

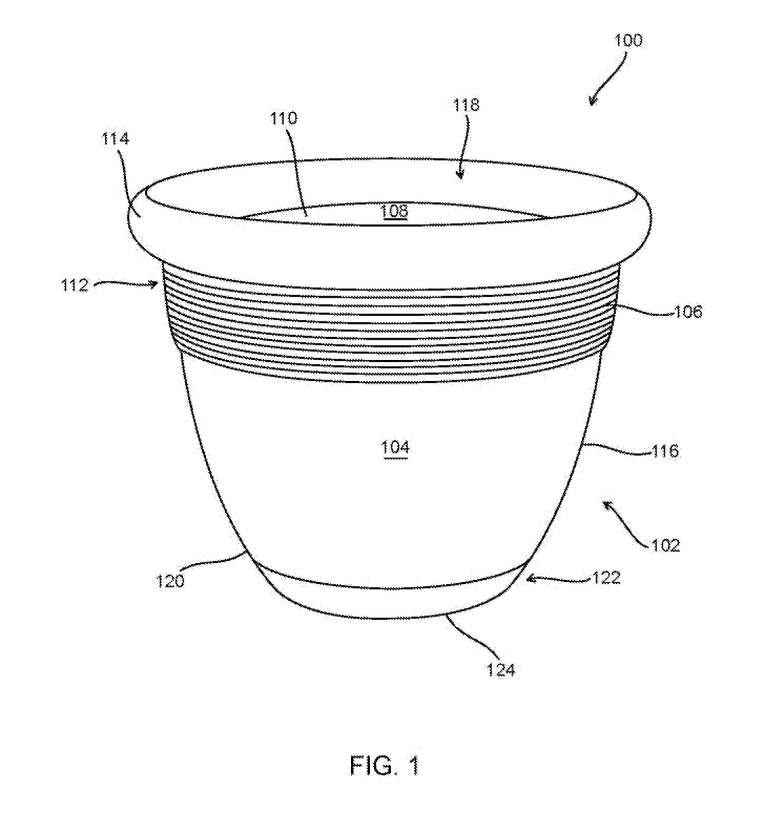

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-5, a pottery ware 100 is adapted to interchange the pot 102 with a detachable saucer 122 and a detachable pedestal 138. The pot that has threaded members for enabling rotatable interchangeability with the saucer 122 and the pedestal 138, which may both be universal, or inline. Additionally, the pottery ware 100 may from a stacked configuration by stacking the pot 102 onto one or more similar pots 200. In some embodiments, drainage through the pot 102 and the saucer 122 may also be possible. The pottery ware 100 exhibited in the present invention may include pottery ware 100 fabricated by forming a clay medium into a pot-shaped container having myriad potential shapes, and then heating to high temperatures in a kiln. The heating process removes moisture from the clay, which induces reactions that lead to permanent changes including increasing strength and hardening and setting the final shape. Additionally, the present invention enables the pottery ware 100 to be decorated before or after firing. However, in other embodiments, any container having a generally elongated form, stacking capacities as described below, drainage capacities as described below, and configured to contain an object or liquid may be used. Suitable materials for fabricating the pottery ware 100 may include, without limitation, composite plastic made mostly of stone powder and polypropylene, thin resin plastic made of either polyethylene, polypropylene, clay, terra cotta, porcelain, earthenware, plastic, fiberglass, metal, and wood. The pottery ware 100 is especially effective for secure stacking of one or more other pots 200, and controlled release of excess water into a detachably joined saucer 122.

As shown in FIG. 1, the pottery ware 100 may include a pot 102 and a detachable saucer 122 and pedestal 138. In some embodiments, the pot 102 may be defined by an outer surface 104 and an inner surface 108 that forms a cavity 110. The pot 102 may also be defined by a base 120, a central region 116, and an opening 118 in communication with the cavity 110. The pot 102 is adapted to be stacked with one or more similar pots 200. The pot 102 may be shaped and dimensioned into various forms, including, without limitation, cylindrical, bell-shaped, frustoconical, or rectangular prism forms. The pot 102 may be used for various purposes, including, without limitation, growing plants, displaying flowers, cooking, and general ornamental affects.

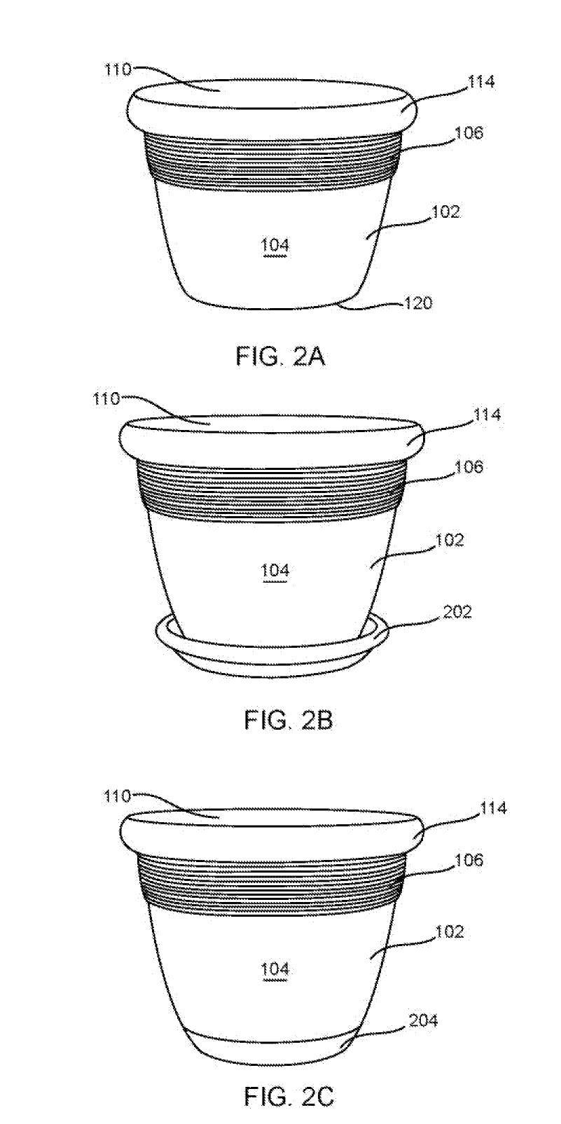

Turning now to FIG. 2A, the pot 102 is shown to have an etched portion 106 arranged on an outer surface 104. The etched portion 106 is configured to create a frictional grip in a section of the outer surface 104 of the pot 102. The etched portion 106 enables the pot 102 to stack with one or more other similar pots 200. The pot 102 may also be defined by a base 120 having at least one base drainage aperture 126 and at least one base ridge 128 that enables controllable passage of excess water into a concentric, detachable saucer 122.

Similarly, the saucer 122 may have at least one saucer drainage aperture 134 that rotates relative to the at least one base drainage aperture 126 to selectively control the flow of water from the pot 102. The saucer 122 can be of any shape and form. For example, FIG. 2B illustrates a universal saucer 202 with a large radial upper flange 136, while FIG. 2C illustrates an inline saucer 204 with substantially no upper flange 136. The pedestal 138 attaches to the bottom of the base 120 or the saucer 122. The pedestal 138 may utilize a plurality of pedestal fasteners 140 to attach thereto. A central pedestal mount 142 is configured to threadably mount to the associated concentric saucer protrusion 132. A pedestal housing 144 provides a protective covering for the pedestal fasteners 140 and creates a decorative appearance.

The outer surface 104 of the pot 102 may include an etched portion 106 that has an uneven surface and slightly protrudes from the outer surface 104. However, in some embodiments, the etched portion 106 is not on the outer surface 104 of the pot 102. When present, the etched portion 106 may be positioned anywhere along the length of the pot 102, from the base 120 to the opening 118. In one embodiment, the etched portion 106 forms a series of circular bands arranged proximally to the opening 118, near an upper end 112 of the pot 102. In one embodiment, a rim 114 may be disposed adjacently to the circular bands (FIG. 1). The series of bands may also have small ridges. The ridges may be formed during the sculpting or heating process to create an uneven, rough outer surface 104. In other embodiments, the etched portion 106 may take the shape of horizontal line, vertical lines, diagonal lines, grids, figures, images, and text. In any case, the etched portion 106 forms an uneven surface, effective for gripping.

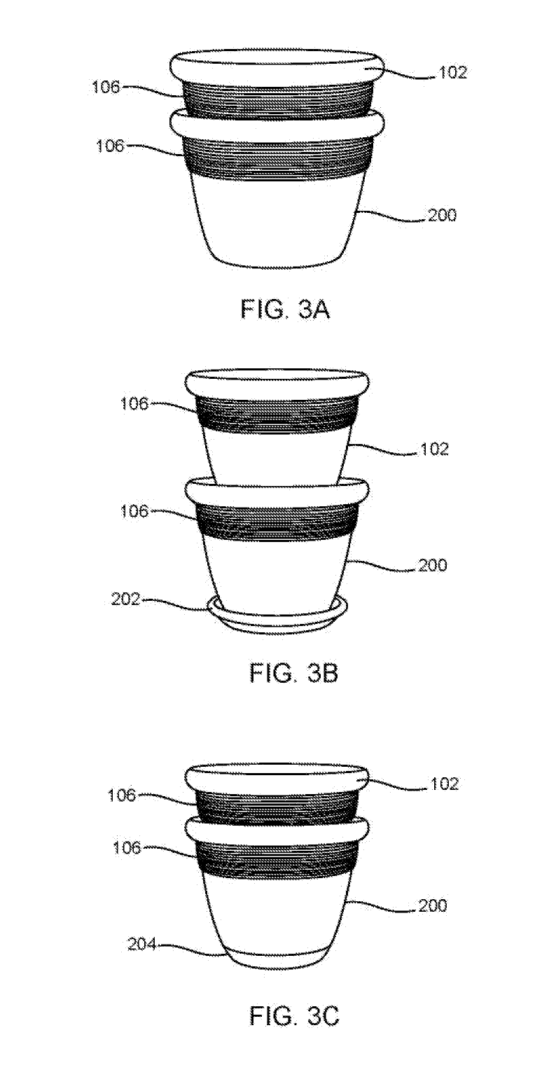

As shown in FIG. 3A, the pot 102 and the at least one other pot 200 may be arranged in a stacked configuration having a generally vertical relationship for particular aesthetic appeal and saving of space. The etched portion 106 on the outer surface 104 of the pot 102 frictionally engages the inner surface 108 of the other pot 200 in the stacked configuration. The etched portion 106 may have small ridges that form an uneven outer surface 104, which is in contrast to the relatively smooth, non-etched surface of the pot 102. The frictional engagement and the ridged surface of the etched portion 106 creates a more stable stacked configuration of the one or more similar other pots 200. Any number of pots 102, 200 may be stacked due to the frictional engagement created by the etched portion 106.

In one embodiment, the pot 102 forms a stacked configuration with one other pot 200 having a saucer 122 and a pedestal 138. Though it is possible that the pot 102 stacks with the other pot 200 that does not have the saucer 122. FIG. 3A shows a stacked configuration of the pot 102 and the one other pot 200 with no saucer 122, whereby the pot 102 and the one other pot 200 fully fit onto each other. FIG. 3B illustrates the stacked configuration with the universal saucer 202. It is significant to note that the etched portion 106 in use with the universal saucer 202 may not fully engage the inner surface 108 of the other pot 200. FIG. 3C illustrates the stacked configuration with the inline saucer 204. The inline saucer 204 forms a seamless appearance.

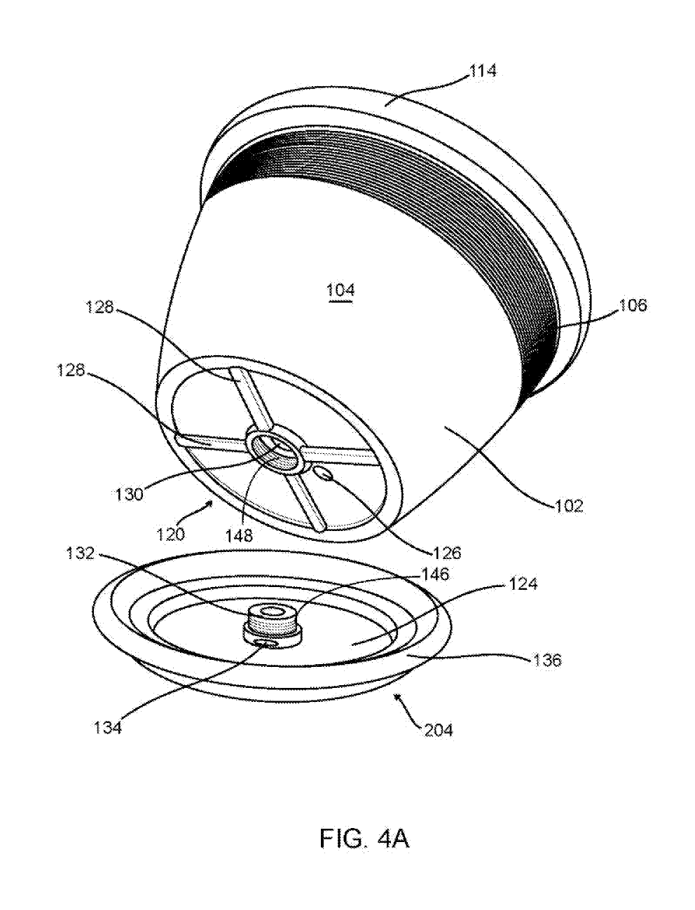

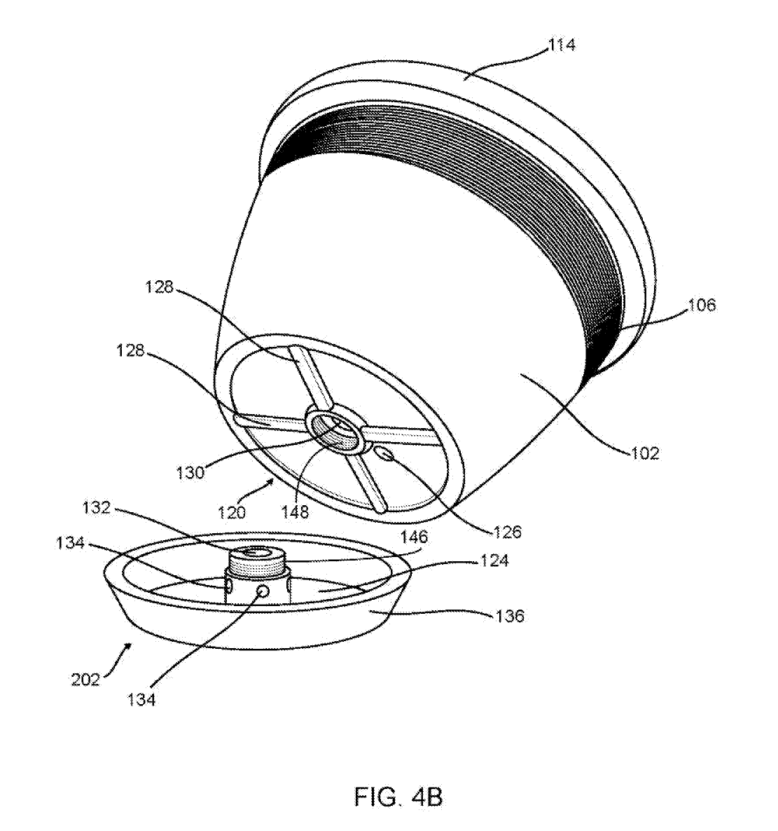

Turning now to FIG. 4A, the base 120 is defined by a generally concentric base connection aperture 130 arranged adjacent to the at least one base drain aperture 126. The saucer 122 is defined by a saucer base 124 having a saucer protrusion 132. The saucer protrusion 132 is defined by a male threaded member 146 that enables rotatable attachment with a female threaded member 148 in the base 120. The base connection aperture 130 engages the saucer protrusion 132 to form a detachable connection between the pot 102 and the saucer 122. The connection between the base connection aperture 130 and the saucer protrusion 132 may use various mating mechanisms, including, without limitation, a threaded surface, friction, a magnets, and adhesives. The saucer protrusion 132 also serves the purpose of forming a plug to restrict the flow of water through the base connection aperture 130.

The base 120 may also include at least one base ridge 128 that slightly protrudes from the surface of the base 120. The at least one base ridge 128 creates additional space between the base 120 and the saucer 122 to enable more water to accumulate in the saucer 122. In one embodiment, the at least one base ridge 128 includes a pair of raised, intersecting lines. However, the at least one base ridge 128 may take any number of shapes, including, grids, triangles, circles, rectangles, text, and figures. In one embodiment, the base 120 of the pot 102 joins with the saucer base 124 for an inline saucer 204 (FIG. 4A). However, in other embodiments, the base 120 of the pot 102 joins with the saucer base 124 120 for a universal saucer 202, which has a larger upper flange 136 (FIG. 4B). However, the functionality is similar with substantially either of the two saucers 202, 204.

Those skilled in the art will recognize that the pottery ware is adaptable to work with a variety of universal saucers 202 and universal pedestals 138. In essence, any number or type of saucers 122 and pedestal 138s are interchangeable on the pot 102. Any combination of saucers 122 and pedestal 138s can be attached, detached, and operational with the pot 102. For example, a universal saucer 202 detachably mates with the pot 102 through the connection between the base connection aperture 130 and the saucer protrusion 132. The universal saucer 202 generally has a high upper flange 136 that provides a perimeter space for collecting falling leaves from the plant, excess water, and the like. In another example of interchangeability, an inline saucer 204 may also be attached to the pot 102. The inline saucer 204 forms a substantially seamless appearance with the base 120 of the pot 102. Additionally, a plurality of eclectic pedestal 138s may be used. The pedestal 138s can be short, tall, wide, decorative, and have myriad other physical attributes. This interchangeable feature allows one body to be configured into multiple types of different pots 102 and urns by means of interchangeable universal saucers 202 and universal pedestals 138.

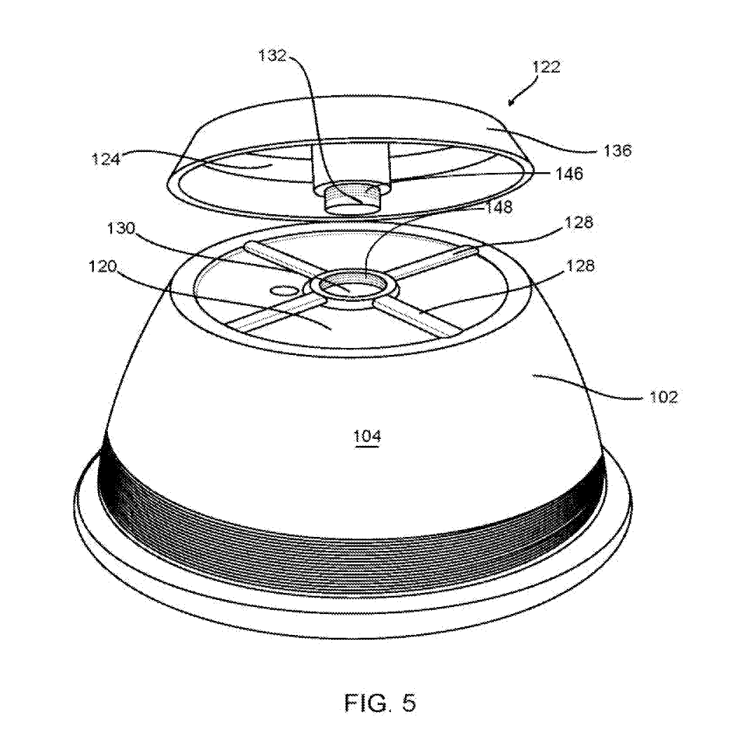

As referenced in FIG. 5, the pot 102 may be used to retain a plant for growth, watering, and display. Following watering, the base 120 of the pot 102 is adapted to purposely direct the flow of the water through at least one base drainage aperture 126, and retain a desired amount of the water within the saucer 122 for a controlled period of time. The saucer 122 may also enable controllable passage of water that accumulates in the saucer base 124 through at least one saucer drainage aperture 134. The saucer drainage aperture 134 may be in communication with the base drainage aperture 126. The saucer 122 may be rotated relative to the base 120 to selectively increase or decrease the flow rate of the water through the respective drainage apertures 126, 134. In this manner, the flow of water can be inhibited sufficiently to timely allow a plant to receive a sufficient amount of moisture.

In one embodiment, the at least one saucer drainage aperture 134 comprises a plurality of circular holes arranged radially around the saucer protrusion 132. However, in other embodiments, a single hole taking any shape could be used as the saucer drainage aperture 134. Furthermore, the saucer 122 may be defined by a radial upper flange 136. The upper flange 136 helps retain the water on the saucer base 124 to prevent overflow and spillage. The upper flange 136 also provides a decorative aspect. Those skilled in the art will recognize that the universal saucer 202 will have a larger upper flange 136 than the inline saucer 204.

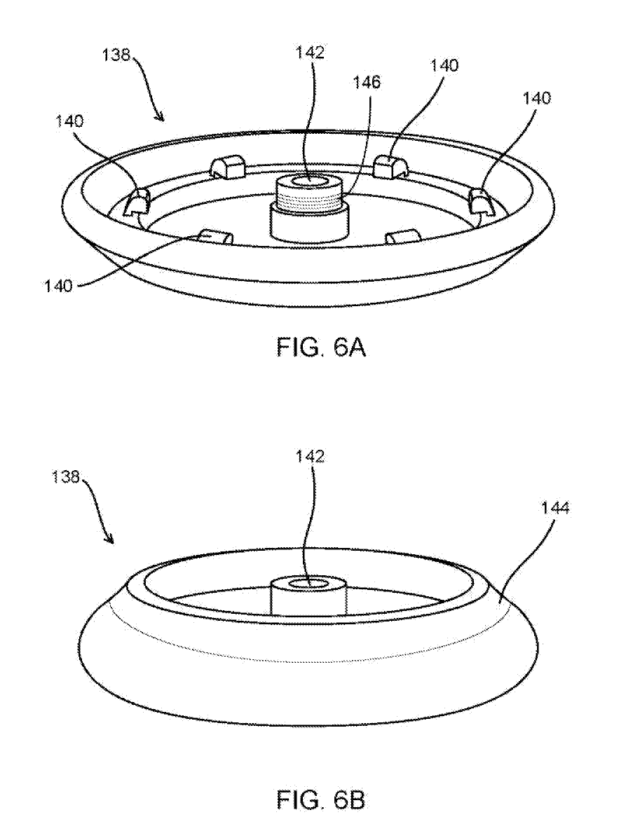

Turning now to FIGS. 6A and 6B, the pedestal 138 attaches to the bottom of the base 120 or the saucer 122. The pedestal 138 may utilize a plurality of pedestal fasteners 140 to attach thereto. A central pedestal mount 142 is configured to threadably mount to the associated concentric saucer protrusion 132. Similar to the saucer 122, the pedestal mount 142 also includes a male threaded member 146 that enables rotatable attachment with a female threaded member 148 in the saucer protrusion 132. A pedestal housing 144 provides a protective covering for the pedestal fasteners 140 and creates a decorative appearance. Suitable materials for the pedestal 138 may include, without limitation, composite plastic made mostly of stone powder and polypropylene, thin resin plastic made of either polyethylene.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A pottery ware that is interchangeable with a saucer and a pedestal, the pottery ware comprising:
a pot, the pot defined by an outer surface and an inner surface, the inner surface configured to form a cavity,
the pot further defined by an opening in communication with the cavity,
the pot further defined by a central region,
the pot further defined by a base, the base comprising at least one base drainage aperture, the base further comprising at least one base ridge, the base further comprising a base connection aperture;
a saucer, the saucer disposed to detachably join with the pot, the saucer defined by a saucer base, the saucer base comprising a saucer protrusion configured to detachably join with the base connection aperture,
the saucer protrusion comprising at least one saucer drainage aperture disposed to selectively communicate with the at least one base drainage aperture,
wherein the saucer is selectively rotated relative to the pot for adjustably aligning the at least one saucer drainage aperture with the at least one base drainage aperture; and
a pedestal, the pedestal disposed to detachably join with the pot.

2. The pottery ware of claim 1, wherein the pot is shaped to include at least one member selected from the group consisting of: bell shape, a cylindrical shape, a frustoconical shape, or a rectangular prism shape.

3. The pottery ware of claim 1, wherein the pot is fabricated from a material to include at least one member selected from the group consisting of: clay, terra cotta, porcelain, earthenware, plastic, fiberglass, metal, and wood.

4. The pottery ware of claim 1, wherein the outer surface comprises an etched portion, the etched portion configured to protrude from the outer surface, the etched portion further configured to form a generally uneven surface, the etched portion comprising an etched band that circles around an upper end of the pot, proximal to the opening.

5. The pottery ware of claim 4, wherein the upper end has a rim.

6. The pottery ware of claim 1, wherein the central region is generally wider than the base.

7. The pottery ware of claim 1, wherein the at least one base drainage aperture is disposed adjacent to the base connection aperture.

8. The pottery ware of claim 1, wherein the base connection aperture is threaded.

9. The pottery ware of claim 1, wherein the at least one base ridge comprises two intersecting ridges, the two intersecting ridges configured to elevate the pot in the saucer.

10. The pottery ware of claim 1, wherein the saucer protrusion is defined by a male threaded member that enables rotatable attachment with a female threaded member in the base.

11. The pottery ware of claim 1, wherein the saucer is to include at least one member selected from the group consisting of: an inline saucer and a universal saucer.

12. The pottery ware of claim 1, wherein the at least one saucer drainage aperture comprises a plurality of circular holes arranged radially around the saucer protrusion.

13. The pottery ware of claim 1, wherein the saucer base is configured to integrally form a radial upper flange.

14. A pottery ware for creating a stacked configuration of one or more pots and forming interchangeability with a saucer and a pedestal, the pottery ware comprising:
a pot, the pot defined by an outer surface, the outer surface comprising an etched portion, the etched portion configured to protrude from the outer surface, the etched portion further configured to form a generally uneven surface,
the pot further defined by an inner surface, the inner surface configured to form a cavity,
wherein the etched portion is configured to frictionally engage the inner surface of one or more similar pots for stabilizing a stacked configuration,
the pot further defined by an opening in communication with the cavity,
the pot further defined by a central region,
the pot further defined by a base, the base comprising at least one base drainage aperture, the base further comprising at least one base ridge, the base further comprising a base connection aperture;
a saucer, the saucer disposed to detachably join with the pot, the saucer defined by a saucer base, the saucer base comprising a saucer protrusion configured to detachably join with the base connection aperture,
the saucer protrusion comprising at least one saucer drainage aperture disposed to selectively communicate with the at least one base drainage aperture,
wherein the saucer is selectively rotated relative to the pot for adjustably aligning the at least one saucer drainage aperture with the at least one base drainage aperture; and
a pedestal, the pedestal disposed to detachably join with the pot.

15. A pottery ware for creating a stacked configuration of one or more pots and forming interchangeability with a saucer and a pedestal, the pottery ware comprising:
a pot, the pot defined by an outer surface,
the pot further defined by an inner surface, the inner surface configured to form a cavity,
wherein the outer surface is configured to frictionally engage the inner surface of one or more similar pots for stabilizing a stacked configuration,
the pot further defined by an opening in communication with the cavity,
the pot further defined by a central region,
the pot further defined by a base, the base comprising at least one base drainage aperture, the base further comprising at least one base ridge, the base further comprising a base connection aperture, the base connection aperture having a threaded surface;
a saucer, the saucer disposed to detachably join with the pot, the saucer defined by a saucer base, the saucer base configured to integrally form a radial upper flange,
the saucer base comprising a saucer protrusion configured to detachably join with the base connection aperture, the saucer protrusion comprising at least one saucer drainage aperture; and
a pedestal, the pedestal disposed to detachably join with the pot and/or the saucer.

16. The pottery ware of claim 15, wherein the pot is shaped to include at least one member selected from the group consisting of: bell shape, a cylindrical shape, a frustoconical shape, or a rectangular prism shape.

17. The pottery ware of claim 15, wherein the pot is fabricated from a material to include at least one member selected from the group consisting of: clay, terra cotta, porcelain, earthenware, plastic, fiberglass, metal, and wood.

18. The pottery ware of claim 15, wherein the central region is generally wider than the base.

19. The pottery ware of claim 15, wherein an upper end of the pot has a rim.

20. The pottery ware of claim 15, wherein the saucer is to include at least one member selected from the group consisting of: an inline saucer and a universal saucer.
